(19) United States
(12) Patent Application Publication
(10) Pub. No.: US 2023/0283763 A1
(43) Pub. Date: Sep. 7, 2023

(54) IMAGE GENERATION APPARATUS, IMAGE GENERATION METHOD, AND PROGRAM

(71) Applicant: SONY GROUP CORPORATION, Tokyo (JP)

(72) Inventor: Takayuki KURIHARA, Tokyo (JP)

(73) Assignee: SONY GROUP CORPORATION, Tokyo (JP)

(21) Appl. No.: 18/001,770

(22) PCT Filed: Jun. 16, 2021
(86) PCT No.: PCT/JP2021/022846

§ 371 Date: Dec. 14, 2022

(30) Foreign Application Priority Data
Jun. 30, 2020 (JP) 2020-113180

(51) Int. Cl. H04N 13/351; H04N 13/117; H04N 13/243; H04N 13/275; H04N 13/282; H04N 13/363; G06T 7/20

(52) U.S. Cl. CPC H04N 13/351; G06T 7/20; H04N 13/117; H04N 13/243; H04N 13/275; H04N 13/282; H04N 13/363

(57) ABSTRACT

An image generation apparatus according to an embodiment of the present technology is an image generation apparatus that generates multi-viewpoint image data for displaying a multi-viewpoint image at a predetermined frame rate, and includes a first generation unit, a generation control unit, and a second generation unit. The first generation unit is capable of generating a plurality of viewpoint images corresponding to a plurality of viewpoint positions. The generation control unit sets one or more target viewpoint positions, which are a part of the plurality of viewpoint positions, for each frame, and causes the first generation unit to generate one or more target viewpoint images corresponding to the set one or more target viewpoint positions. The second generation unit generates the multi-viewpoint image data using the one or more target viewpoint images generated for each frame.

### TECHNICAL FIELD

The present technology relates to an image generation apparatus, an image generation method, and a program applicable to display of a multi-viewpoint image.

### BACKGROUND ART

Patent Literature 1 discloses a technique for updating a background for generating a virtual viewpoint image with high accuracy and with a low processing load.

Specifically, in order to reproduce the background on a three-dimensional space, the background shape is divided into partial regions. Then, an input image captured by the camera is divided for each partial region. The input image divided for each partial region is compared with the input image of the corresponding partial region of a directly previous frame, and importance is determined for each partial region. Based on the determined importance, it is determined whether or not to update the input image for each partial region (paragraphs [0012], [0020] to [0023], etc. of Patent Literature 1).

### CITATION LIST

### Patent Literature

Patent Literature 1: Japanese Patent Application Laid-open No. 2018-136793

### DISCLOSURE OF INVENTION

### Technical Problem

As described above, there is a need for a technique capable of displaying a multi-viewpoint image with a low processing load.

In view of the above circumstances, an object of the present technology is to provide an image generation apparatus, an image generation method, and a program capable of reducing a processing load for generating a viewpoint image.

### Solution to Problem

In order to achieve the above object, an image generation apparatus according to an embodiment of the present technology is an image generation apparatus that generates multi-viewpoint image data for displaying a multi-viewpoint image at a predetermined frame rate, and includes a first generation unit, a generation control unit, and a second generation unit.

The first generation unit is capable of generating a plurality of viewpoint images corresponding to a plurality of viewpoint positions.

The generation control unit sets one or more target viewpoint positions, which are a part of the plurality of viewpoint positions, for each frame, and causes the first generation unit to generate one or more target viewpoint images corresponding to the set one or more target viewpoint positions.

The second generation unit generates the multi-viewpoint image data using the one or more target viewpoint images generated for each frame.

In this image generation apparatus, the one or more target viewpoint images corresponding to the one or more target viewpoint positions that are part of the plurality of viewpoint positions are generated for each frame. Thus, for each frame, the one or more target viewpoint images that are part of the plurality of viewpoint images are generated. This makes it possible to reduce a processing load for generating the viewpoint image.

The second generation unit may generate the multi-viewpoint image data of a predetermined frame using the one or more target viewpoint images generated in the predetermined frame and the one or more target viewpoint images generated in frames former than the predetermined frame.

The generation control unit may generate one or more first target viewpoint images corresponding to one or more first target viewpoint positions in a first frame, and may generate one or more second target viewpoint images corresponding to one or more second target viewpoint positions different from any of the one or more first target viewpoint positions in a second frame consecutive to the first frame.

The second generation unit may generate the multi-viewpoint image data of the second frame using the one or more first target viewpoint images and the one or more second target viewpoint images.

The generation control unit may set an update frame number, divide the plurality of viewpoint positions into a plurality of target viewpoint position groups having the same number as the update frame number and in which the target viewpoint positions are not overlapped with each other, assign each of the plurality of target viewpoint position groups to each of consecutive frames of the update frame number, and generate a target viewpoint image group corresponding to the assigned target viewpoint position group in each of the plurality of frames.

The generation control unit may set the update frame number to 2, divide the plurality of viewpoint positions into a first target viewpoint position group and a second target viewpoint position group in which the target viewpoint positions are not overlapped with each other, assign the first target viewpoint position group and the second target viewpoint position group to two consecutive frames, and generate a first target viewpoint image group corresponding to the assigned first target viewpoint position group and a second target viewpoint image group corresponding to the assigned second target viewpoint position group in each of the two frames.

The generation control unit may be capable of changing the update frame number.

The generation control unit may change the update frame number based on a movement of an object to be displayed or a mode set for a multi-viewpoint image display.

The generation control unit may set the one or more target viewpoint positions based on an interpupillary distance for each frame and generate the one or more target viewpoint images.

The generation control unit may divide the plurality of viewpoint positions into the plurality of target viewpoint position groups based on the interpupillary distance.

The second generation unit may generate the multi-viewpoint image data of a predetermined frame using the one or more target viewpoint images generated in the predetermined frame and the multi-viewpoint image data generated in a former frame than the predetermined frame.

The first generation unit may generate a virtual image as the viewpoint image.

The first generation unit may acquire a plurality of captured images from a plurality of imaging devices arranged in the plurality of viewpoint positions as the plurality of viewpoint images. In this case, the generation control unit may cause the first generation unit to output captured images corresponding to the one or more target viewpoint images and to discard other captured images for each frame.

The generation control unit may set the one or more target viewpoint positions based on position information of a user for each frame and generate the one or more target viewpoint images.

The second generation unit may generate the multi-viewpoint image data as data for multi-viewpoint display of a multi-viewpoint display apparatus.

The multi-viewpoint display apparatus may include a plurality of projectors. In this case, the second generation unit may generate a plurality of corresponding multi-viewpoint image data corresponding to each of the plurality of projectors as the multi-viewpoint image data.

The multi-viewpoint display apparatus may include a multi-viewpoint display. The second generation unit may generate the multi-viewpoint image data corresponding to the multi-viewpoint display.

An image generation method according to an embodiment of the present technology is an image generation method executed by a computer system for generating multi-viewpoint image data for displaying a multi-viewpoint image at a predetermined frame rate, and includes setting one or more target viewpoint positions that are part of a plurality of viewpoint positions for each frame, generating one or more target viewpoint images corresponding to the set one or more target viewpoint positions, and generating the multi-viewpoint image data using the generated one or more target viewpoint images for each frame.

The one or more target viewpoint images generated for each frame are used to generate the multi-viewpoint image data.

A program according to an embodiment of the present technology causes a computer system to execute the image generation method.

### BRIEF DESCRIPTION OF DRAWINGS

FIG. 1 is a schematic diagram showing a basic configuration example of an image display system according to an embodiment.

FIG. 2 is a chart showing an example of a basic operation of the image display system.

FIG. 3 is a schematic diagram showing a configuration example of a multi-viewpoint display apparatus (projector array).

FIG. 4 is a schematic diagram showing an example of generation of multi-viewpoint image data.

FIG. 5 is a schematic diagram showing a configuration example of a multi-viewpoint display apparatus (multi-viewpoint display).

FIG. 6 is diagrams each explaining a display of a stereoscopic image.

FIG. 7 is a schematic diagram showing a functional configuration example of an image generation apparatus.

FIG. 8 is a schematic diagram for explaining an example of setting one or more target viewpoint positions.

FIG. 9 is a chart showing an example of generation of the multi-viewpoint image data.

FIG. 10 is schematic diagrams each explaining the generation of the multi-viewpoint image data.

FIG. 11 is a chart showing generation of multi-viewpoint image data as a comparative embodiment.

FIG. 12 is a schematic diagram showing a case where an update frame number is set to 3.

FIG. 13 is a schematic diagram for explaining setting the target viewpoint positions based on an interpupillary distance.

FIG. 14 is a schematic diagram showing a functional configuration example of an image generation apparatus according to other embodiment.

FIG. 15 is a chart showing an example of generation of the multi-viewpoint image data.

FIG. 16 is a schematic diagram showing a functional configuration example of an image generation apparatus according to other embodiment.

FIG. 17 is a block diagram showing a hardware configuration example of the image generation apparatus.

### MODE(S) FOR CARRYING OUT THE INVENTION

Embodiments according to the present technology will now be described below with reference to the drawings.

### Basic Configuration of Image Display System

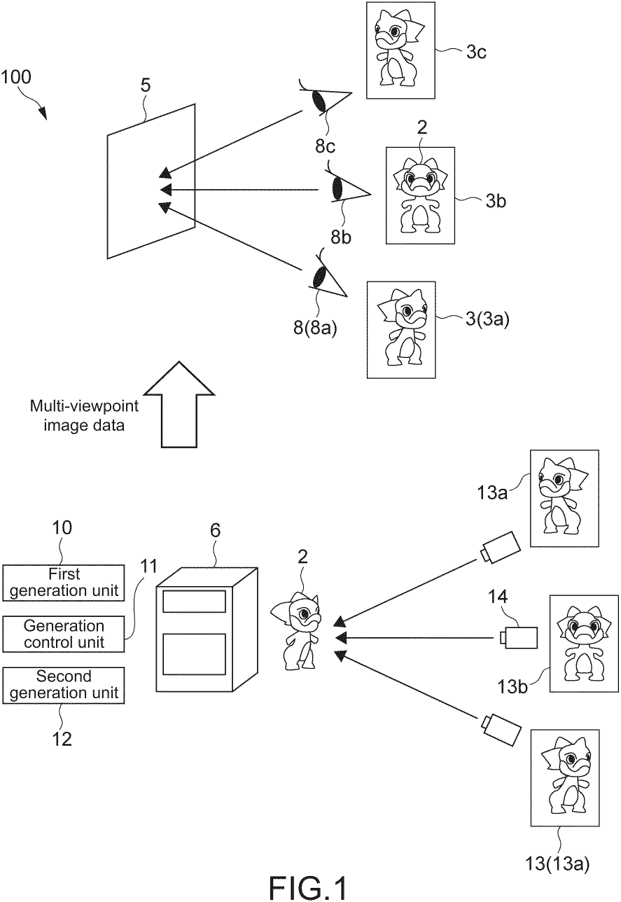

FIG. 1 is a schematic diagram showing an example of a basic configuration of an image display system according to an embodiment of the present technology.

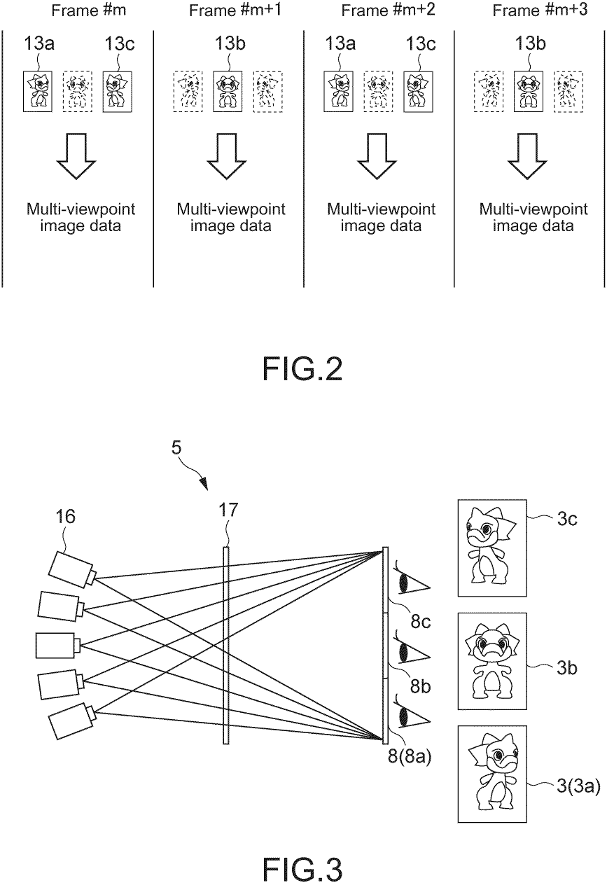

FIG. 2 is a chart showing an example of basic operation of the image display system.

As shown in FIG. 1, an image display system 100 includes a multi-viewpoint display apparatus 5 and an image generation apparatus 6.

The multi-viewpoint display apparatus 5 and the image generation apparatus 6 are communicably connected via a wired or wireless communication. A connection configuration between apparatuses is not limited, and wireless LAN communication such as WiFi or short-range wireless communication such as Bluetooth (registered trademark) can be used, for example.

The multi-viewpoint display apparatus 5 can display a multi-viewpoint image.

The multi-viewpoint image is an image capable of displaying an image 3 corresponding to each of a plurality of viewpoint positions 8. A user (observer) can observe different images by changing an observation position (i.e., viewpoint position 8).

For example, as shown in FIG. 1, an image 3b is displayed when viewing a cartoon character 2 from front corresponding to a viewpoint position 8b to be a front position with respect to the multi-viewpoint display apparatus 5.

An image 3a is displayed when viewing the cartoon character 2 from a left side corresponding to a viewpoint position 8a which is a position moved from the front viewpoint position 8b to the left side with respect to the multi-viewpoint display apparatus 5.

An image 3c is displayed when viewing the cartoon character 2 from a right side corresponding to a viewpoint position 8c which is a position moved from the front viewpoint position 8b to the right side with respect to the multi-viewpoint display apparatus 5.

It should be appreciated that it is not limited to such a multi-viewpoint image and an arbitrary image may be displayed for each viewpoint position 8.

In the present image display system 100, the multi-viewpoint display apparatus 5 displays the multi-viewpoint image based on multi-viewpoint image data generated by the image generation apparatus 6.

A specific configuration example of the multi-viewpoint display apparatus 5 will be described later.

The image generation apparatus 6 generates the multi-viewpoint image data for displaying the multi-viewpoint image at a predetermined frame rate.

In the present disclosure, the image includes both a still image and a moving image (video).

Furthermore, generating the multi-viewpoint image data at the predetermined frame rate corresponds to generating the image data of the multi-viewpoint image displayed at the predetermined frame rate. That is, the multi-viewpoint image data includes image data of the multi-viewpoint image displayed in each frame. In the following description, the image data of the multi-viewpoint image displayed in each frame will be described as the multi-viewpoint image data of each frame.

In the present disclosure, generating the image at the predetermined frame rate is not limited to generating the moving image (video). The present technology is also applicable to a case where the image has a relatively high frame rate and is displayed such that the still image is advanced frame-by-frame to a viewer. It should be appreciated that such an image display can be regarded as a display of the moving image (video).

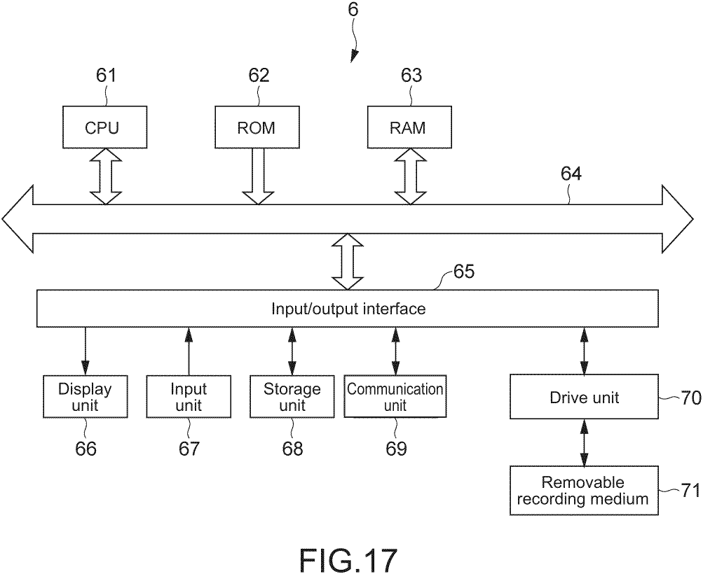

The image generation apparatus 6 includes hardware necessary for a configuration of a computer such as a processor, e.g., a CPU, a GPU, or a DSP, a memory, e.g., a ROM or a RAM, and a storage device, e.g., an HDD. It should be appreciated that hardware such as an FPGA and an ASIC may be used (see FIG. 17).

For example, an image generation method according to the present technology is executed by loading a program according to the present technology, which is recorded in the ROM or the like in advance, into the RAM and executing the program.

The image generation apparatus 6 can be implemented by any computer such as a personal computer (PC), for example. It should be appreciated that hardware such as the FPGA and the ASIC may be used.

In the present embodiment, the processor executes a predetermined program to configure a first generation unit 10, a generation control unit 11, and a second generation unit 12 as functional blocks. It should be appreciated that dedicated hardware such as an integrated circuit (IC) may be used in order to implement the functional blocks.

The program is installed on the image generation apparatus 6 via various recording media, for example. Alternatively, the program may be installed via the Internet or the like.

A type and the like of the recording medium that records the program are not limited and any computer-readable recording medium may be used. For example, any non-transitory computer-readable recording medium may be used.

The first generation unit 10 can generate a plurality of viewpoint images 13 corresponding to the plurality of viewpoint positions 8.

As shown in FIG. 1, a plurality of viewpoint images 13a to 13c correspond to the images 3a to 3c observed from the respective viewpoint positions 8 displayed by the multi-viewpoint display apparatus 5.

Incidentally, the images 3a to 3c observed by the user from the respective viewpoint positions 8 are also called as the viewpoint images. In the present disclosure, in order to facilitate understanding of the description, the image (image data) generated mainly by the first generation unit 10 is described as the viewpoint image.

In the present embodiment, the viewpoint image 13 is generated by a CG (computer graphics). More specifically, virtual cameras 14 are arranged so as to surround an object to be displayed (cartoon character 2 shown in FIG. 1) as a center.

Then, a virtual image captured from each virtual camera 14 is generated as the viewpoint image 13. This makes it possible to acquire images when the object is viewed from different angles.

The positions where the virtual cameras 14 are arranged are set corresponding to the viewpoint positions 8 defined with respect to the multi-viewpoint display apparatus 5. Conversely, the viewpoint positions 8 where the user can observe the object at different angles are defined based on the positions where the virtual cameras 14 are arranged.

The generation of the viewpoint image 13 by the first generation unit 10 can also be referred to as rendering of the viewpoint image 13. The viewpoint image 13 may also be referred to as a rendering image.

It should be appreciated that the number of viewpoint positions 8 is not limited and can be arbitrarily set. By setting many viewpoint positions 8, it is possible to observe the cartoon character 2 from various angles and to provide a high-quality viewing experience.

The generation control unit 11 controls the generation of the plurality of viewpoint images 13 by the first generation unit 10.

In the present embodiment, the generation control unit 11 sets one or more target viewpoint positions, each of which is a part of the plurality of viewpoint positions 8, for each frame. The generation control unit 11 causes the first generation unit 10 to generate one or more target viewpoint images corresponding to the set one or more target viewpoint positions.

That is, the generation control unit 11 determines which viewpoint image 13 is to be generated for each frame. The viewpoint image 13 generated in each frame based on the determination is the target viewpoint image.

In the example shown in FIG. 2, in the frames (#m) and (#m+2), the viewpoint positions 8a and 8c that are parts of the three viewpoint positions 8a to 8c are set as the target viewpoint positions to be generated of the viewpoint images 13. Then, the viewpoint images 13a and 13c corresponding to the viewpoint positions 8a and 8c are generated as the target viewpoint images.

In the frames (#m+1) and (#m+3), the viewpoint position 8b which is a part of the three viewpoint positions 8a to 8c is set as the target viewpoint position to be generated of the viewpoint images 13. Then, the viewpoint image 13b corresponding to the viewpoint position 8b is generated as the target viewpoint image.

As described above, in the present embodiment, the viewpoint images 13 corresponding to all the viewpoint positions 8 are not generated for each frame but a part of the one or more target viewpoint images corresponding to the part of the one or more target viewpoint positions are generated. That is, not all of the viewpoint images 13 but a part of the one or more target viewpoint images is generated for each frame.

Which viewpoint position 8 is set as the one or more target viewpoint positions for each frame is not limited and may be arbitrarily set.

The second generation unit 12 generates the multi-viewpoint image data using the one or more target viewpoint images generated for each frame. The second generation unit 12 generates the multi-viewpoint image data for each frame.

The multi-viewpoint image data is generated as data for multi-viewpoint display of the multi-viewpoint display apparatus 5. Therefore, the multi-viewpoint image data is generated in accordance with the configuration of the multi-viewpoint display apparatus 5 and a multi-viewpoint display method.

For example, the plurality of viewpoint images 13 generated by the first generation unit 10 is appropriately converted in accordance with the configuration of the multi-viewpoint display apparatus 5 and the multi-viewpoint display method, and the multi-viewpoint image data is generated.

In the present embodiment, the second generation unit 12 generates the multi-viewpoint image data using the one or more target viewpoint images generated for each frame. That is, the one or more target viewpoint images generated in each frame are used to generate the multi-viewpoint image data for each frame.

In the present disclosure, processing using image data is not limited to processing using only the image data. Arbitrary processing using at least the image data is included.

### Multi-Viewpoint Image Display

Referring to FIGS. 3 to 5, a specific example of the multi-viewpoint display apparatus 5 will be described.

The multi-viewpoint display apparatus 5 shown in FIG. 3 has a plurality of projectors 16 and a ray control element 17.

The plurality of projectors 16 is each capable of projecting the images and is configured as a projector array.

In the multi-viewpoint display apparatus 5 shown in FIG. 3, five projectors 16 and five ray control elements 17 allow to display the images 3a to 3c corresponding to the three viewpoint positions 8a to 8c, respectively.

A specific configuration of the projectors 16 is not limited, and any configuration may be employed.

As the ray control element 17, for example, a transmission type anisotropic diffusion screen is used.

The transmission type anisotropic diffusion screen has diffusion characteristics of different anisotropy diffusivities, for example, in the horizontal and vertical directions. For example, it is configured such that the diffusivity in the horizontal direction is set smaller than that in the vertical direction so as to have narrow diffusion characteristics with respect to the horizontal direction.

By arranging the anisotropic diffusion screen, it is possible to display the image 3 corresponding to each viewpoint position 8 with an appropriate width. A specific configuration of the anisotropic diffusion screen is not limited. For example, a lens diffusion plate including a microlens array or the like, a transmission type HOE (Holographic Optical Element), or the like can be used as the anisotropic diffusion screen.

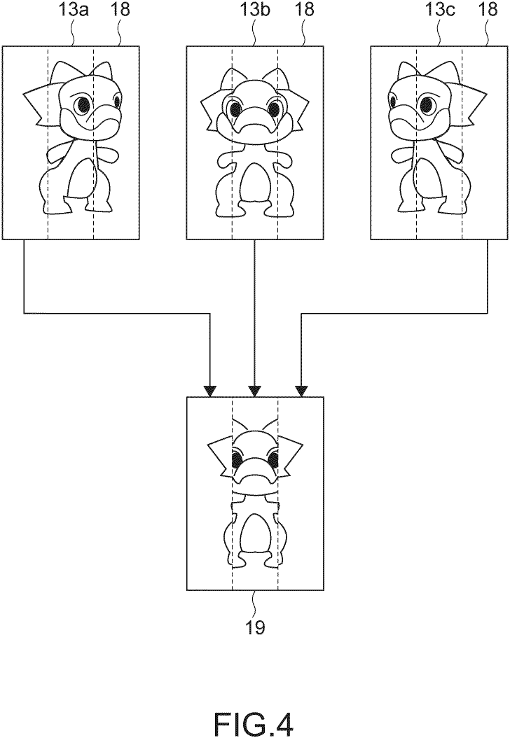

As shown in FIG. 4, in the present embodiment, the viewpoint images 13a to 13c corresponding to the respective three viewpoint positions 8a to 8c are divided into a plurality of regions having strip shapes along the lateral direction of the image (hereinafter, image in divided region is described as strip image 18).

The divided strip images 18 are appropriately rearranged and image data of a projection image 19 projected from each projector 16 is generated. Based on the image data, the projection image 19 is projected by each projector 16.

Therefore, the projection image 19 including the strip images 18 of the respective viewpoint images 13 different from each other is projected from one projector 16. In addition, the projection image 19 including only one strip image 18 may be projected from the other projector 16.

The user views the projection image 19 projected from the projectors 16 different from each other, i.e., the image 3 where the strip images 18 corresponding to the viewpoint positions 8 are synthesized at each viewpoint position 8. As a result, a multi-viewpoint image display is realized.

Hereinafter, the image data and the image displayed based on the image data may be described with reference to the same drawings. For example, the projection image 19 shown in FIG. 4 may be described as the image data of the projection image 19.

For the multi-viewpoint display apparatus 5 shown in FIG. 3, the second generation unit 12 rearranges the strip images 18 of the respective viewpoint images 13 to generate the multi-viewpoint image data.

Specifically, the strip images 18 are rearranged to generate the image data of the projection image 19 corresponding to each of the plurality of projectors 16. The plurality of image data corresponding to each of the plurality of projectors 16 is generated as the multi-viewpoint image data.

Note that the plurality of image data corresponding to each of the plurality of projectors 16 corresponds to the plurality of corresponding multi-viewpoint image data corresponding to each of the plurality of projectors 16.

A rearrangement of the strip images 18 can be realized using the well-known technology, for example, based on the number of projectors 16, the number of viewpoint positions 8, or the like.

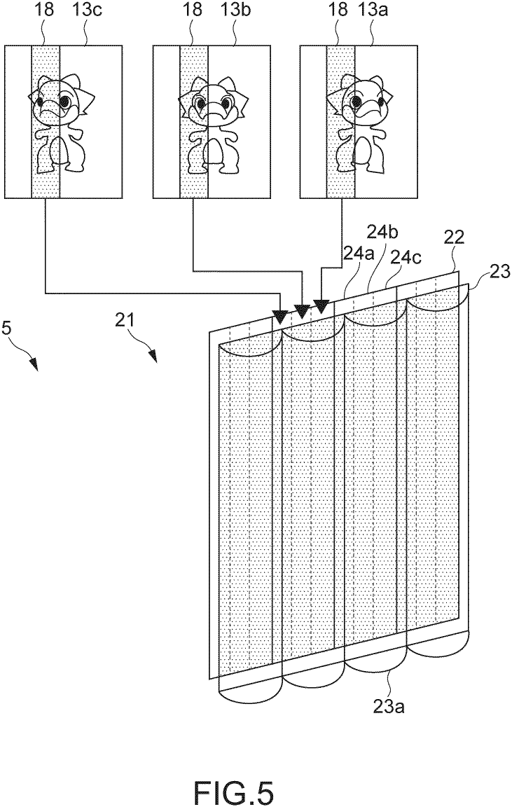

The multi-viewpoint display apparatus 5 shown in FIG. 5 has a multi-viewpoint display 21.

The multi-viewpoint display 21 allows the images 3 corresponding to the plurality of viewpoint positions 8 to simultaneously display toward the respective viewpoint positions 8.

The multi-viewpoint display 21 may be configured by any one of a lenticular lens system, a lens array system, and a parallax barrier system, for example. It should be appreciated that it is not limited to these systems.

The multi-viewpoint display 21 shown in FIG. 5 has a flat display panel 22 and a lenticular lens 23.

The flat display panel 22 has a plurality of pixels arranged in the horizontal and vertical directions. The lenticular lens 23 is arranged along the vertical direction.

In the example shown in FIG. 5, the viewpoint images 13a to 13c corresponding to the respective three viewpoint positions 8a to 8c are divided into the plurality of strip images 18 along the lateral direction of the image.

The divided strip images 18 are appropriately rearranged to generate the image data of a display image to be displayed by the flat display panel 22. Based on the image data, the display image is displayed by the flat display panel 22.

As shown in FIG. 5, for example, the pixel regions opposing to four convex portions 23a of the lenticular lens 23 are each divided into three regions 24a to 24c along the horizontal direction. The strip images 18 of the three viewpoint images 13 are assigned to the three divided regions. It should be appreciated that it is not limited to such a rearrangement.

The user views the strip images 18 at the respective viewpoint positions 8 where a beam direction toward each viewpoint position 8 is controlled by the lenticular lens 23. As a result, the multi-viewpoint image display is realized.

For the multi-viewpoint display apparatus 5 shown in FIG. 5, the second generation unit 12 rearranges the strip images 18 of the respective viewpoint images 13 and generates the multi-viewpoint image data. The multi-viewpoint image data is multi-viewpoint image data corresponding to the multi-viewpoint display 21. The rearrangement of the strip images 18 can be realized by using a well-known technology based on, for example, the configuration of the multi-viewpoint display 21.

As compared with the configuration using the projector array, an entire apparatus can be designed compactly in the configuration using the multi-viewpoint display 21.

### Display of Stereoscopic Image

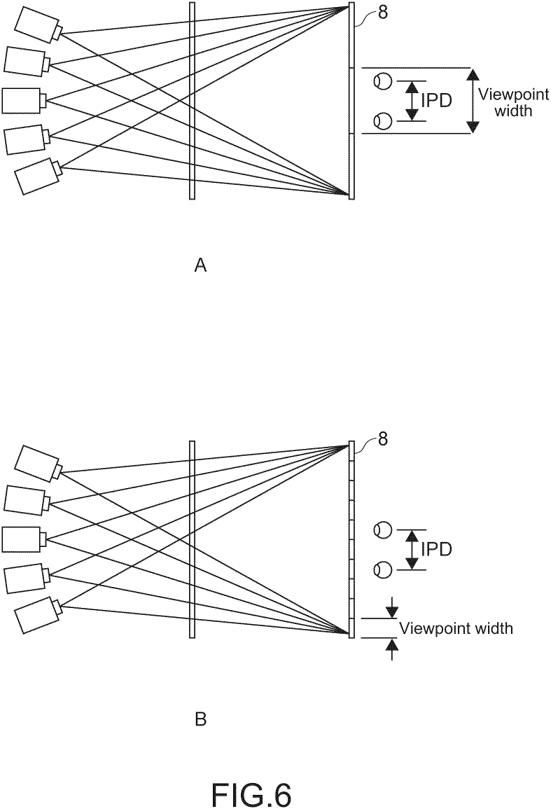

FIG. 6 is diagrams each explaining display of a stereoscopic image.

For each viewpoint position 8, a width (range) where the same image 3 (same viewpoint image) can be observed is defined as a viewpoint width.

As shown in FIG. 6A, when the viewpoint width is larger than the interpupillary distance (IPD), in many cases, the user observes the same image with both eyes. Accordingly, the user observes a planar image (2D image).

As shown in FIG. 6B, when the viewpoint width is smaller than the interpupillary distance (IPD), parallax images can be displayed as the image 3 (viewpoint image) corresponding to the viewpoint position 8. Therefore, the user can observe different parallax images (right-eye image, left-eye image) with both eyes and can observe a stereoscopic image (3D image).

The present technology can be applied to any of the display of the planar image and the display of the stereoscopic image.

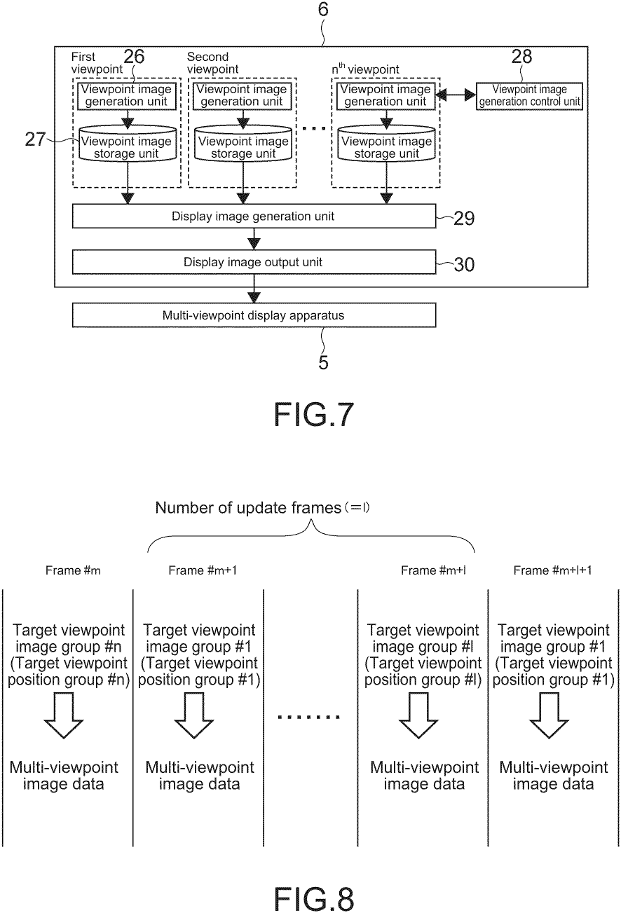

FIG. 7 is a schematic diagram showing a functional configuration example of the image generation apparatus 6.

The image generation apparatus 6 includes a plurality of viewpoint image generation units 26, a plurality of viewpoint image storage units 27, a viewpoint image generation control unit 28, a display image generation unit 29, and a display image output unit 30.

The plurality of viewpoint image generation units 26, the viewpoint image generation control unit 28, the display image generation unit 29, and the display image output unit 30 are configured by, for example, the processor executing the predetermined program. It should be appreciated that dedicated hardware such as an integrated circuit (IC) may be used for realizing these functional blocks.

The plurality of viewpoint image storage units 27 is realized by, for example, an HDD, a flash memory, or other solid-state memory. Any storage device may be used without limitation.

The plurality of viewpoint image generation units 26 is configured corresponding to the plurality of viewpoint positions 8. That is, one viewpoint image generation unit 26 is configured for one viewpoint position 8. Therefore, the plurality of viewpoint image generation units 26 is configured by the number of viewpoint positions 8.

In the present embodiment, it is assumed that n viewpoint positions 8 from a first viewpoint to n^{th} viewpoint are defined as the viewpoint positions 8. Accordingly, n viewpoint image generation units 26 are configured.

The n viewpoint image generation units 26 generate the viewpoint images 13 corresponding to the respective n viewpoint positions 8.

The plurality of viewpoint image storage units 27 is configured corresponding to the plurality of viewpoint image generation units 26. That is, one viewpoint image storage unit 27 is configured for one viewpoint image generation unit 26. Accordingly, n viewpoint image storage units 27 equal to the number of the viewpoint positions 8 are configured.

As surrounded by broken lines in FIG. 7, it can be said that one pair of the viewpoint image generation unit 26 and the viewpoint image storage unit 27 are configured with respect to one viewpoint position 8.

The n viewpoint image storage units 27 store the viewpoint images 13 generated by the paired viewpoint image generation units 26.

The viewpoint image generation control unit 28 controls the generation of the viewpoint image 13 by each viewpoint image generation unit 26 for each frame.

Specifically, the viewpoint image generation control unit 28 sets the one or more target viewpoint positions, which are a part of the plurality of viewpoint positions 8, for each frame. The viewpoint image generation control unit 28 causes the viewpoint image generation unit 26 to generate the one or more target viewpoint images corresponding to the set one or more target viewpoint positions.

Therefore, the viewpoint image generation control unit 28 determines which viewpoint image 13 is to be generated for each frame. The viewpoint image 13 generated in each frame based on the determination is the target viewpoint image.

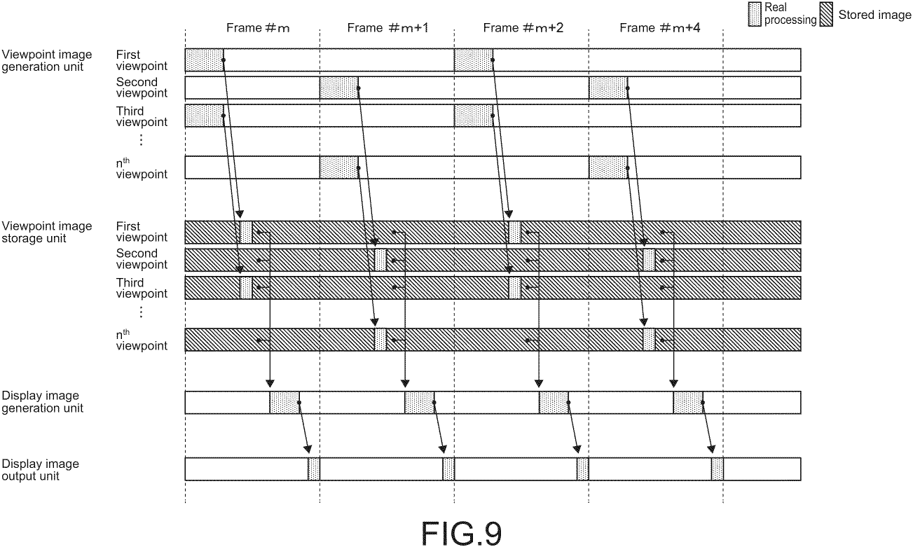

FIG. 8 is a schematic diagram for explaining an example of setting the one or more target viewpoint positions.

An update frame number is set by the viewpoint image generation control unit 28. The update frame number is the frame number required for updating all the viewpoint images 13. Conversely, the update frame number is the frame number allocated for updating all the viewpoint images 13.

In the present embodiment, all the viewpoint images 13 are updated over consecutive frames of the update frame number.

In FIG. 8, the update frame number = 1 is set. Then, all the viewpoint images 13 are updated by 1 consecutive frames (#m+1) to (#m+1).

The viewpoint image generation control unit 28 divides the plurality of viewpoint positions 8 into a plurality of target viewpoint position groups having the same number as the update frame number in which the target viewpoint positions do not overlap with each other. In FIGS. 8, 1 target viewpoint position groups (#1) to (#1) are set.

The target viewpoint positions included in each target viewpoint position group are set so as not to overlap with each other. Therefore, the update frame number is equal to or less than the total number of viewpoint positions 8.

As shown in FIG. 8, each of the plurality of target viewpoint position groups (#1) to (#1) is assigned to each of the consecutive frames (#m+1) to (#m+1) of the update frame number (=1). Then, in the respective plurality of frames (#m+1) to (#m+l), target viewpoint image groups (#1) to (#l) corresponding to the assigned target viewpoint position groups (#1) to (#l) are generated.

For example, the target viewpoint image group (#3) is a group of the target viewpoint images corresponding to the respective target viewpoint positions included in the plurality of target viewpoint position groups (#3) assigned to the frame (#m+3) .

In the example shown in FIG. 8, updating of all the viewpoint images 13 is realized in the l consecutive frames (#m+1) to (#m+l). Furthermore, by repeating the processing of the consecutive frames (#m+1) to (#m+l), updating of all the viewpoint images 13 is also repeated.

A way to set the update frame number and the target viewpoint position group is not limited and may be arbitrarily set.

For example, the update frame number is set to 2 (l=2). For example, an odd-numbered frame and a consecutive even-numbered frame are frames (#m+1) and (#m+2).

If P viewpoint positions 8 are set, indices of 1 to P are added from the end in order. That is, each viewpoint position is identified by designation of a first viewpoint position 8 or a P-th viewpoint position. It should be appreciated that the method of identifying the viewpoint position 8 such as an indexing method is not limited.

The P viewpoint positions 8 are divided into a target viewpoint position group (#1) including the odd-numbered viewpoint positions 8 and a target viewpoint position group (#2) including the even-numbered viewpoint positions 8. That is, every other viewpoint is set to be included in different groups of the target viewpoint positions.

The target viewpoint position group (#1) and the target viewpoint position group (#2) are assigned to two consecutive frames (#m+1) and (#m+2). Then, in each of the two frames (#m+1) and (#m+2), the target viewpoint image group (#1) corresponding to the assigned target viewpoint position group (#1) and the target viewpoint image group (#2) corresponding to the assigned target viewpoint position group (#2) are generated.

Thus, for each of the two frames, updating of all the viewpoint images 13 may be executed.

In the present embodiment, the target viewpoint position groups (#1) and (#2) represent an embodiment of the first target viewpoint position group and the second target viewpoint position group in which the target viewpoint positions are not overlapped with each other.

The target viewpoint image group (#1) and the target viewpoint image group (#2) represent an embodiment of a first target viewpoint image group corresponding to the assigned first target viewpoint position group and a second target viewpoint image group corresponding to the assigned second target viewpoint position group.

It should be appreciated that it is not limited thereto and three target viewpoint position groups may be assigned to three consecutive frames and three target viewpoint image groups may be repeatedly generated.

The display image generation unit 29 reads the viewpoint images 13 corresponding to the respective viewpoint positions 8 from the n viewpoint image storage units 27 and generates the multi-viewpoint image data.

For example, as described with reference to FIG. 4, FIG. 5, and the like, the rearrangement or the like of the strip images 18 obtained by dividing the viewpoint images 13 is executed to generate the multi-viewpoint image data. As shown in FIG. 7, the multi-viewpoint image data can also be referred to as the display image (display image data).

For example, in the example shown in FIG. 8, the target viewpoint image group (#l) generated in the frame (#m+l) and the target viewpoint image group (#1 to #l-1) generated in the respective frames (#m+1 to #m+l-1) former than the frame (#m+l) are used to generate the multi-viewpoint image data of the frame (#m+l).

In this case, the frame (#m+l) represents an embodiment of a predetermined frame according to the present technology. The respective target viewpoint image groups correspond to one or more target viewpoints.

In a frame other than the frame (#m+1), similarly, the target viewpoint image groups (one or more target viewpoint images) generated in the frame and the target viewpoint image groups (one or more target viewpoint images) generated in the frames former than the frame are used to generate the multi-viewpoint image data of the frame.

The display image output unit 30 outputs the multi-viewpoint image data generated for each frame to the multi-viewpoint display apparatus 5.

In the example shown in FIG. 7, by the plurality of viewpoint image generation units 26, the first generation unit 10 shown in FIG. 1 is realized.

By the viewpoint image generation control unit 28, the generation control unit 11 shown in FIG. 1 is realized.

By the display image generation unit 29, the second generation unit 12 shown in FIG. 1 is realized.

Incidentally, the viewpoint image generation control unit 28 is not included and each viewpoint image generation unit 26 may determine whether or not the viewpoint image 13 is generated for each frame. In this case, the plurality of viewpoint image generation units 26 also function as the generation control unit 11 shown in FIG. 1.

In the example shown in FIG. 8, two consecutive frames are arbitrarily selected from the consecutive frames (#m+1) to (#m+l). The former frame of the two consecutive frames is set as a first frame and the latter frame is set as a second frame.

The target viewpoint position groups assigned to the first frame are one or more first target viewpoint positions. The target viewpoint position groups assigned to the second frame are defined as one or more second target viewpoint positions.

The target viewpoint images corresponding to the one or more first target viewpoint positions are set as one or more first target viewpoint images. The target viewpoint images corresponding to the one or more second target viewpoint positions are defined as one or more second target viewpoint images.

In this case, the viewpoint image generation control unit 28 generates the one or more first target viewpoint images corresponding to the one or more first target viewpoint positions in the first frame and generates the one or more second target viewpoint images corresponding to the one or more second target viewpoint positions different from any of the one or more first target viewpoint positions in the second frame consecutive to the first frame.

The display image generation unit 29 generates multi-viewpoint image data of the second frame using the one or more first target viewpoint images and the one or more second target viewpoint images.

Note that overlapping of the target viewpoint positions may be allowed for each of the plurality of target viewpoint position groups shown in FIG. 8. For example, overlapping of the target viewpoint positions may be allowed between the one or more first target viewpoint positions assigned to the first frame and the one or more second target viewpoint positions assigned to the second frame.

The image generation method executed by the image generation apparatus according to the present technology is not limited to a case where the processing of frames (#m+1) to (#m+l) is repeated as shown in FIG. 8, for example.

For example, for two consecutive frames, the above processing is executed at least once, with these frames being the first frame and the second frame. The multi-viewpoint image data of the second frame is generated using the one or more first target viewpoint images and the one or more second target viewpoint images. Such processing is also included in an embodiment of the image generation method executed by the image generation apparatus according to the present technology.

In other words, if the processing of generating the one or more target viewpoint images, which are not the all viewpoint images 13 but a part of the viewpoint images 13 is executed in at least one frame and the multi-viewpoint image data is generated based on the generated one or more target viewpoint images, it is included in one embodiment of the image generation method executed by the image generation apparatus according to the present technology.

### Generation of Multi-Viewpoint Image Data

FIG. 9 is a chart showing an example of generation of the multi-viewpoint image data.

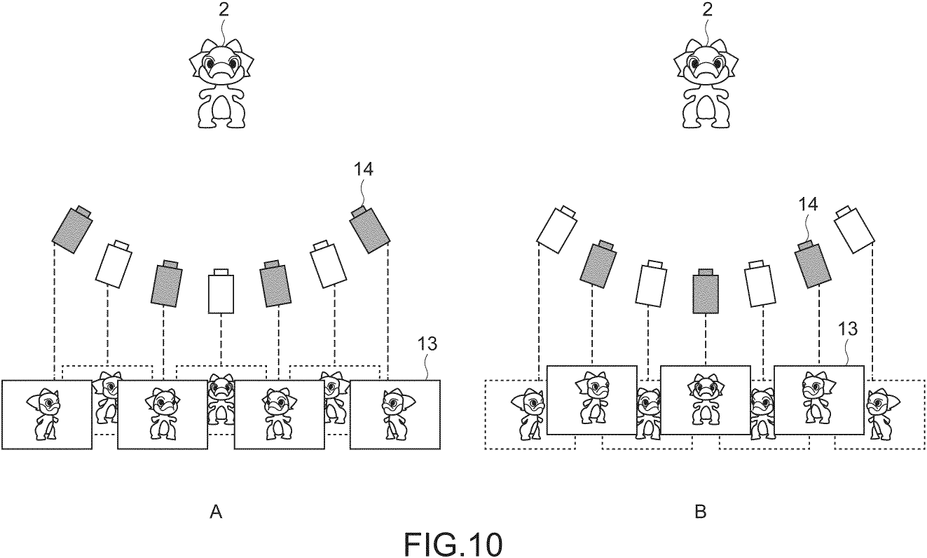

FIG. 10 is schematic diagrams each explaining the generation of multi-viewpoint image data.

As shown in FIG. 9, it is assumed that n viewpoint positions 8 from the first viewpoint to n^{th} viewpoint are set. Then, corresponding to the n viewpoint positions 8, the n viewpoint image generation units 26 and the n viewpoint image storage units 27 are configured.

FIG. 10 shows the case where n=7.

In the present embodiment, the update frame number is set to 2 (L=2).

Then, in the odd frame, the odd-numbered viewpoint positions 8 are set as the target viewpoint position groups (one or more target viewpoint positions). In the even-numbered frame, the even-numbered viewpoint positions 8 are set as the target viewpoint position groups (one or more target viewpoint positions). Note that m in FIG. 10 is an odd number.

The one or more target viewpoint images corresponding to the one or more target viewpoint positions which are the odd-numbered viewpoint positions 8 are generated by the viewpoint image generation unit 26 in the odd-numbered frame (#m) and are stored in the viewpoint image storage unit 27. The viewpoint images 13 corresponding to the even-numbered viewpoint positions 8 are not generated.

In the examples shown in FIG. 10A, the first, third, fifth, and seventh viewpoint positions 8 are set as the target viewpoint positions. The virtual images (viewpoint images 13) of the cartoon character 2 captured by the virtual cameras 14 arranged at positions corresponding to the viewpoint positions 8 are generated as the target viewpoint images.

The display image generation unit 29 reads the viewpoint images 13 corresponding to all the viewpoint positions 8 from all the viewpoint image storage units 27.

For the odd-numbered viewpoint positions 8, the one or more target viewpoint images generated in the frame (#m) are read. For the even-numbered viewpoint positions 8, the one or more target viewpoint images generated in the directly previous even-numbered frame (#m-1) former than the frame (#m) are read.

Based on all the read viewpoint images 13, the multi-viewpoint image data is generated.

The generated multi-viewpoint image data is output to the multi-viewpoint display apparatus 5 by the display image output unit 30.

In the even-numbered frame (#m+1), the one or more target viewpoint images corresponding to the one or more target viewpoint positions, which are the even-numbered viewpoint positions 8, are generated and stored in the viewpoint image storage unit 27. The viewpoint images 13 corresponding to the odd-numbered viewpoint positions 8 are not generated.

In the examples shown in FIG. 10B, the second, fourth, and sixth viewpoint positions 8 are the target viewpoint positions. The virtual images (viewpoint images 13) of the cartoon character 2 captured by the virtual cameras 14 arranged at the positions corresponding to the viewpoint positions 8 are generated as the target viewpoint images.

The display image generation unit 29 reads the viewpoint images 13 corresponding to all the viewpoint positions 8 from all the viewpoint image storage units 27.

For the even-numbered viewpoint positions 8, the one or more target viewpoint images generated in the frame (#m+1) are read. For the odd-numbered viewpoint positions 8, the one or more target viewpoint images generated in the directly previous odd-numbered frame (#m) former than the frame (#m+1) are read.

Based on all the read viewpoint images 13, the multi-viewpoint image data is generated.

The generated multi-viewpoint image data is output to the multi-viewpoint display apparatus 5 by the display image output unit 30.

As described above, in the image generation apparatus 6 according to the present embodiment, the one or more target viewpoint images corresponding to the one or more target viewpoint positions which are part of the plurality of viewpoint positions 8 are generated for each frame. Therefore, the one or more target viewpoint images that are part of the plurality of viewpoint images 13 are generated for each frame. This makes it possible to reduce a processing load for generating the viewpoint image 13.

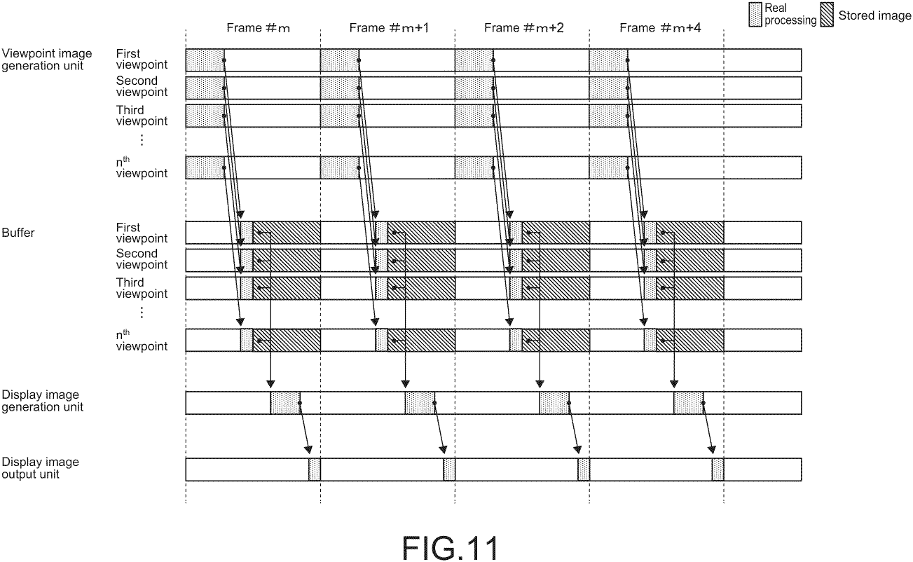

FIG. 11 is a chart showing generation of multi-viewpoint image data as a comparative example.

In the comparative example shown in FIG. 11, the viewpoint images 13 corresponding to all the viewpoint positions 8 are generated in each frame. The generated viewpoint images 13 are temporarily stored in a buffer and are used to generate the multi-viewpoint image data by the display image generation unit.

In the comparative example shown in FIG. 11, since all the viewpoint images 13 are generated in each frame, a load (rendering load) required for generating the viewpoint images 13 is increased. In addition, an amount of data handled in each frame increases and a display frame rate of the multi-viewpoint image decreases.

In the comparative example shown in FIG. 11, assuming that the large number of viewpoint positions 8 is set, the rendering load further increases and the display frame rate further decreases. Therefore, it becomes necessary to reduce a quality of the video such as lowering a resolution of the image and it is difficult to realize a high-quality multi-viewpoint display.

In the image generation apparatus 6 according to the present embodiment, the number of viewpoint images 13 acquired for each frame is suppressed and all the viewpoint images 13 are sequentially updated for each of the plurality of frames.

Thus, it is possible to sufficiently suppress costs (rendering load) of generating the viewpoint images 13 per frame and it is possible to sufficiently suppress the amount of data to be handled. As a result, it is possible to improve the display frame rate of the multi-viewpoint image without decreasing the quality of the video and it is possible to realize the high-quality multi-viewpoint display.

Furthermore, it is also possible to reduce required specifications of the image generation apparatus 6.

### Other Embodiments

The present technology is not limited to the embodiments described above and various other embodiments can be implemented.

A value of the update frame number shown in FIG. 8 is not limited and may be arbitrarily set.

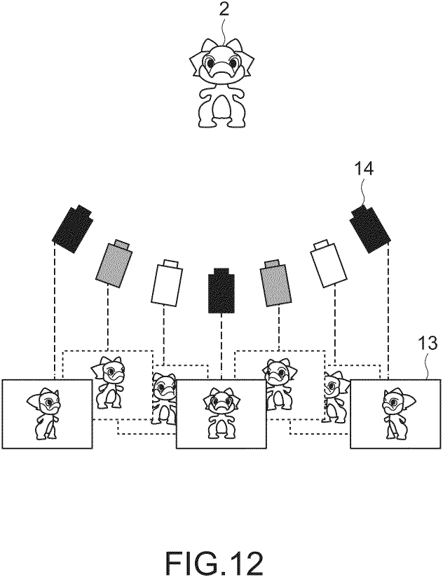

For example, FIG. 12 is a schematic diagram showing a case where the update frame number is set to 3 (l=3).

The update frame number is a parameter that determines an interval (cycle) where all the viewpoint images 13 are updated. Therefore, a setting of the update frame number corresponds to a setting of an update cycle.

The update frame number may be arbitrarily changed by the viewpoint image generation control unit 28.

As the update frame number increases, the load of processing per frame decreases, but since an acquisition timing of the individual viewpoint images 13 deviates, there is a possibility that an object having a motion may experience a sense of discomfort.

For example, the update frame number can be arbitrarily changed by the viewpoint image generation control unit 28 based on a movement of the object to be displayed. As a result, it is possible to balance the processing load and a motion deviation in a trade-off relationship described above.

For example, when behavior of the object is fast or large, the update frame number is reduced and all the viewpoint images 13 are updated at a short update cycle. When the behavior of the display object is slow or the change is small, the update frame number is increased and the update cycle for updating all the viewpoint images 13 is increased.

In this manner, by making the update cycle (i.e., update frame number) variable in accordance with the movement of the object, it is possible to reduce the processing load while reducing a perception of the deviation of the object.

The update cycle of the viewpoint images 13 may be determined according to a mode set by the user.

The mode is a mode relating to the multi-viewpoint image display and any mode such as a mode for prioritizing a performance of the multi-viewpoint image display (high-quality display mode, etc.) and a mode for prioritizing a low load (low power consumption mode, etc.) can be employed.

For example, when the user selects the mode for prioritizing the performance, by shortening an update interval, it is possible to reduce a probability of perceived motion deviation of the object. Furthermore, when the mode for prioritizing the low load is selected, by increasing the update interval, the processing load can be reduced.

In addition, the update cycle (update frame number) may be set based on a state of the user acquired by camera tracking or the like.

It should be appreciated that the update frame number may be fixed to a preset constant.

For each frame, the interpupillary distance (IPD) may be used as to which viewpoint positions 8 are to be set as the one or more target viewpoint positions.

That is, for each frame, the one or more target viewpoint positions may be set based on the interpupillary distance (IPD) and the one or more target viewpoint images may be generated.

In the example shown in FIG. 8, the plurality of viewpoint positions may be divided into the plurality of target viewpoint position groups based on the interpupillary distance (IPD).

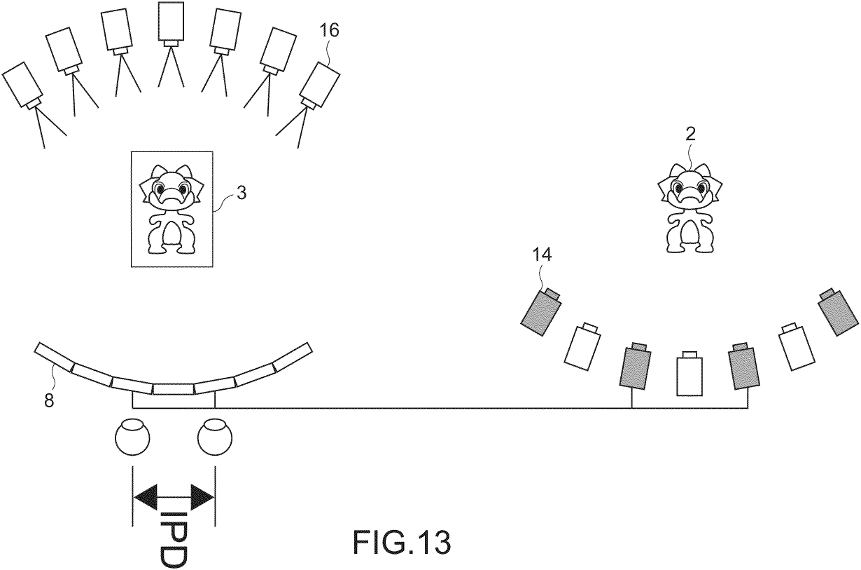

For example, as shown in FIG. 13, a group of the virtual cameras 14 for the viewpoint images 13 acquired in a single frame, i.e., a group of the target viewpoint positions, may be determined by the user’s assumed interpupillary distance (IPD) at an observed position.

The interpupillary distance IPD may be set to a predetermined value, or a value obtained by the camera tracking or the like may be used.

Considering the IPD, when the user is at rest, the left and right eyes of the user can see the updated viewpoint image 13 at the same timing, making it difficult to perceive the motion deviation of the object.

For example, the processing is applied when displaying the stereoscopic image shown in FIG. 6B. As a result, since the right-eye image and the left-eye image are updated at the same timing, a high-quality stereoscopic display is realized.

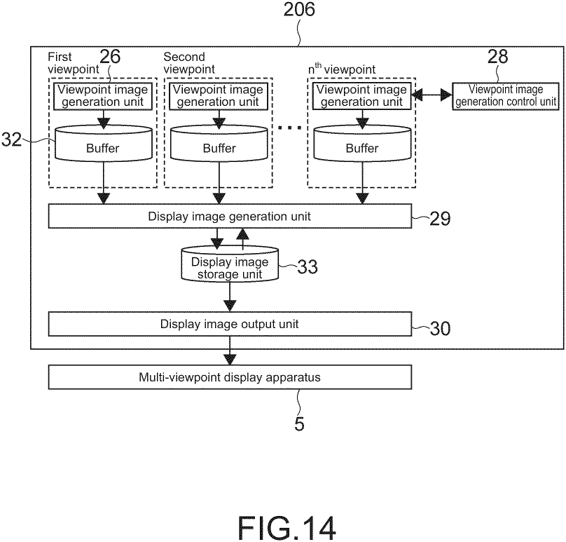

FIG. 14 is a schematic diagram showing a functional configuration example of an image generation apparatus according to other embodiment.

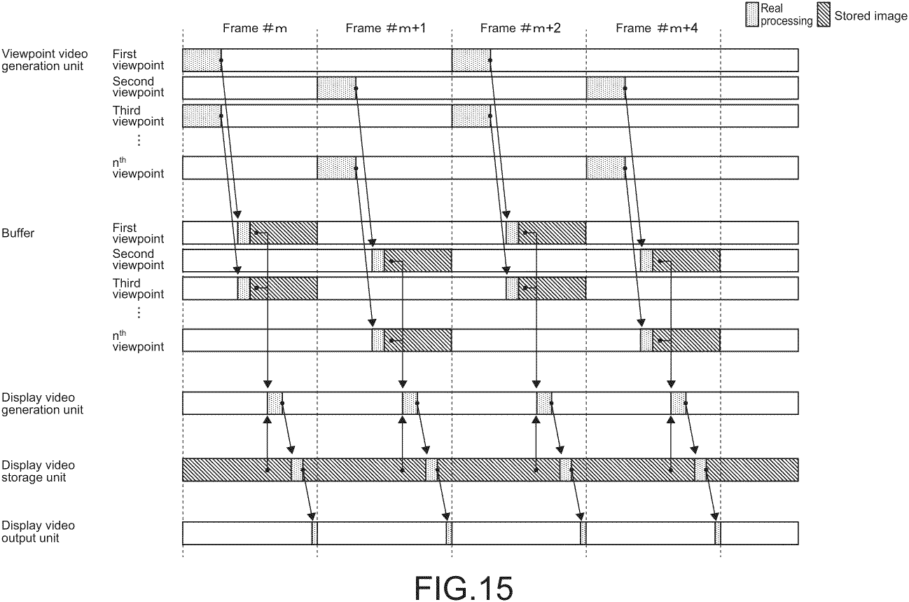

FIG. 15 is a chart showing an example of generation of the multi-viewpoint image data.

In the image generation apparatus 206 shown in FIG. 14, a plurality of buffers 32 are configured instead of the plurality of viewpoint image storage units 27. A display image storage unit 33 is configured.

In the present embodiment, in each frame, the one or more target viewpoint images corresponding to the one or more target viewpoint positions are generated and temporarily stored in the buffer 32.

In the present embodiment, in each frame, the multi-viewpoint image data (display image) generated by the display image generation unit 29 is stored in the display image storage unit 33.

The display image generation unit 29 reads the one or more target viewpoint images temporarily stored in the buffer 32 in each frame. The display image generation unit 29 reads the multi-viewpoint image data generated in the former frame from the display image storage unit 33.

Then, the display image generation unit 29 generates the multi-viewpoint image data using the one or more target viewpoint images of the current frame and multi-viewpoint image data of the former frame.

As described above, in the present embodiment, the multi-viewpoint image data of the predetermined frame is generated using the one or more target viewpoint images generated in the predetermined frame and the multi-viewpoint image data generated in the frame former than the predetermined frame.

As shown in FIG. 15, in generating a series of the multi-viewpoint image data (display image), instead of storing and holding the view image 13, the display image after the strip images 18 are rearranged may be stored and held.

The display image generation unit 29 loads the display image after the rearrangement of the previous frame and rearranges only the corresponding portion of the acquired viewpoint images 13 to update the display image. The display image generated by the update is generated as final multi-viewpoint image data.

In a case where the load of the rearrangement processing of the viewpoint images 13 for generating the display image is large or the like, the entire load can be reduced by the present embodiment where the multi-viewpoint image data after rearrangement is held.

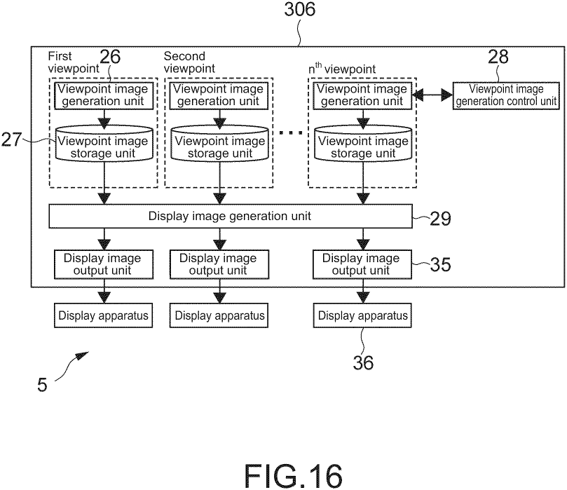

FIG. 16 is a schematic diagram showing a functional configuration example of an image generation apparatus according to other embodiment.

In an image generation apparatus 306 shown in FIG. 16, a plurality of display image output units 35 are configured.

For example, when the projector array as shown in FIG. 3 is used as the multi-viewpoint display apparatus 5, the image generation apparatus 306 is connected to a plurality of display apparatuses 36.

The plurality of display image output units 35 are configured in accordance with the number of the plurality of display apparatuses 36. Then, the plurality of display image output units 35 are connected to each of the plurality of display apparatuses 36.

When there are the plurality of display apparatuses 36 as output destinations such as the configuration in which the multi-viewpoint display apparatus 5 uses the projector array, efficiency of the multi-viewpoint display is improved by making the display image output unit 35 correspond to the display apparatuses 36 in a one-to-one manner.

Instead of the camera 14, a camera array may be used as a real object to acquire a real image.

In generating the viewpoint image 13, instead of using the virtual camera 14 on the CG, the camera array may be installed on a real space to generate the viewpoint images 13 from the object in the real space. Even when the viewpoint images 13 are generated from the object in the real space, a method of suppressing the generation of the viewpoint images 13 according to the present technology can be applied in the same manner.

For example, the first generation unit 10 acquires a plurality of captured images from a plurality of imaging apparatuses arranged in the plurality of viewpoint positions 8 as the plurality of viewpoint images 13.

The generation control unit 11 causes, for each frame, the first generation unit 10 to output the captured images corresponding to the one or more target viewpoint images and to discard other captured images. That is, in the present embodiment, the output of the captured images by the first generation unit 10 correspond to the generation of the target viewpoint images by the first generation unit 10.

According to the present embodiment, not only the CG but also the real object can be displayed on the multi-viewpoint display apparatus 5. For example, it is possible to copying the target viewpoint images (captured images) output from the first generation unit 10 mainly to the buffer to thereby reducing the costs. It should be appreciated that it is not limited to such effects.

Position information of the user may be used to set which viewpoint positions 8 as the one or more target viewpoint positions for each frame.

That is, the one or more target viewpoint positions may be set based on position information of the user and the one or more target viewpoint images may be generated.

A method of acquiring the position information of the user is not limited and any method such as the camera tracking or the like may be used. Furthermore, the position information of the user may be estimated by machine learning.

If generation positions of the viewpoint images are limited to observer positions, the video cannot be observed at other positions, but the generated viewpoint images 13 can be drastically reduced, so that the processing load can be reduced and the display frame rate can be improved.

In addition to or instead of the position information of the user, line-of-sight information of the user may be used.

FIG. 17 is a block diagram showing an example of a hardware configuration of the image generation apparatus 6.

The image generation apparatus 6 includes a CPU 61, a ROM (Read Only Memory) 62, a RAM 63, an input/output interface 65, and a bus 64 that connects them to each other. The input and output interface 65 is connected to a display unit 66, an input unit 67, a storage unit 68, a communication unit 69, a drive unit 70, and the like.

The display unit 66 is, for example, a display device using a liquid crystal, an EL, or the like. The input unit 67 is, for example, a keyboard, a pointing device, a touch panel, or other operation device. In a case where the input unit 67 includes the touch panel, the touch panel may be integrated with the display unit 66.

The storage unit 68 is a non-volatile storage device and is, for example, an HDD, a flash memory, or other solid-state memory. The drive unit 70 is a device capable of driving a removable recording medium 71 such as an optical recording medium and a magnetic recording tape.

The communication unit 69 is a modem, a router, or other communication device that can be connected to a LAN, a WAN, or the like for communicating with other devices. The communication unit 69 may communicate using either wired or wireless communication. The communication unit 69 is often used separately from the image generation apparatus 6.

Information processing (image generation) by the image generation apparatus 6 having the above-described hardware configuration is realized in cooperation with software stored in the storage unit 68, ROM 62, or the like and hardware resources of the image generation apparatus 6. Specifically, the information processing method (image generation method) according to the present technology is implemented by loading the program that is stored in the ROM 62 or the like and configures the software into the RAM 63 and by executing the program.

The program is installed in the image generation apparatus 6 via, for example, the recording medium 61. Alternatively, the program may be installed in the image generation apparatus 6 via a global network or the like. Moreover, any non-transitory computer readable storage medium may be used.

A plurality of computers communicably connected via a network or the like may cooperate to execute the image generation method and the program according to the present technology, thereby constructing the image generation apparatus according to the present technology.

That is, the image generation method and the program according to the present technology can be executed not only in a computer system including a single computer but also in a computer system in which a plurality of computers operate in conjunction with each other.

Note that, in the present disclosure, the system refers to a set of components (such as apparatuses and modules (parts)) and it does not matter whether all of the components are in a single housing. Thus, a plurality of apparatuses accommodated in separate housings and connected to each other through a network, and a single apparatus in which a plurality of modules is accommodated in a single housing are both the system.

Execution of the image generation method and the program according to the present technology by the computer system include both cases in which, for example, the generation of the viewpoint images, the setting of the target viewpoint positions, the generation of the multi-viewpoint image data, or the like is executed by the single computer and in which each processing is executed by different computers. Furthermore, the execution of each processing by a specified computer includes causing other computer to execute a portion of or all of the processing and acquiring a result thereof.

That is, the image generation method and the program according to the present technology can be applied to a configuration of cloud computing in which one function is shared among a plurality of devices through a network and processed together.

Each configuration, each processing flow or the like of the image generation system, the multi-viewpoint display apparatus, the image generation apparatus or the like described with reference to the drawings is merely one embodiment and may be arbitrarily modified without departing from the scope of the present technology. In other words, for example, any other configurations or algorithms for practicing the present technology may be employed.

When the term “approximately” is used in the present disclosure, it is used merely to facilitate understanding of the description, and the use/non-use of the term “approximately” is not particularly meaningful.

That is, in the present disclosure, a concept defining a shape, a size, a positional relationship, a status, and the like, such as “central,” “center,” “uniform,” “equal,” “same,” “orthogonal,” “parallel,” “symmetric,” “extended,” “axial,” “columnar,” “cylindrical,” “ring,” “annular,” and the like, is a concept including “substantially central,” “substantially center,” “substantially uniform,” “substantially equal,” “substantially same,” “substantially orthogonal,” “substantially parallel,” “substantially symmetric,” “substantially extended,” “substantially axial,” “substantially columnar,” “substantially cylindrical,” “substantially ring,” “substantially annular,” and the like.

For example, a status included in a predetermined range (e.g., ±10% range) based on “perfectly central,” “perfectly center,” “perfectly uniform,” “perfectly equal,” “perfectly same,” “perfectly orthogonal,” “perfectly parallel,” “perfectly symmetric,” “perfectly extended,” “perfectly axial,” “perfectly columnar,” “perfectly cylindrical,” “perfectly ring,” “perfectly annular,” and the like is also included.

Therefore, even when the term “approximately” is not added, a conceptual expressed by adding a so-called “approximately” may be included. On the contrary, a complete status is not excluded for the status represented by the addition of “approximately”.

In the present disclosure, an expression “larger than A” or “smaller than A” is an expression comprehensively including both a concept including a case which is equivalent to A and a concept not including a case which is equivalent to A. For example, the expression “larger than A” is not limited to a case which is equivalent to A and includes “larger than A”. The expression “smaller than A” is not limited to a case which is “less than A” and includes a case which is “A or less”.

When the present technology is implemented, specific settings and the like may be appropriately employed from the concept included in “larger than A” and “smaller than A” so that the effects described above are exhibited.

At least two of the features of the present technology described above can also be combined. In other words, various features described in the respective embodiments may be arbitrarily combined regardless of the embodiments. Furthermore, the various effects described above are not limitative but are merely illustrative, and other effects may be provided.

The present technology may also have the following structures.

An image generation apparatus that generates multi-viewpoint image data for displaying a multi-viewpoint image at a predetermined frame rate, including:
a first generation unit capable of generating a plurality of viewpoint images corresponding to a plurality of viewpoint positions;
a generation control unit that sets one or more target viewpoint positions, which are a part of the plurality of viewpoint positions, for each frame, and causes the first generation unit to generate one or more target viewpoint images corresponding to the set one or more target viewpoint positions; and
a second generation unit that generates the multi-viewpoint image data using the one or more target viewpoint images generated for each frame.

The image generation apparatus according to (1), in which

the second generation unit generates the multi-viewpoint image data of a predetermined frame using the one or more target viewpoint images generated in the predetermined frame and the one or more target viewpoint images generated in frames former than the predetermined frame.

The image generation apparatus according to (1) or (2), in which

the generation control unit generates one or more first target viewpoint images corresponding to one or more first target viewpoint positions in a first frame, and generates one or more second target viewpoint images corresponding to one or more second target viewpoint positions different from any of the one or more first target viewpoint positions in a second frame consecutive to the first frame.

The image generation apparatus according to (3), in which

the second generation unit generates the multi-viewpoint image data of the second frame using the one or more first target viewpoint images and the one or more second target viewpoint images.

The image generation apparatus according to any one of (1) to (4), in which
the generation control unit
sets an update frame number,
divides the plurality of viewpoint positions into a plurality of target viewpoint position groups having the same number as the update frame number and in which the target viewpoint positions are not overlapped with each other,
assigns each of the plurality of target viewpoint position groups to each of consecutive frames of the update frame number, and
generates a target viewpoint image group corresponding to the assigned target viewpoint position group in each of the plurality of frames.

The image generation apparatus according to (5), in which
the generation control unit
sets the update frame number to 2,
divides the plurality of viewpoint positions into a first target viewpoint position group and a second target viewpoint position group in which the target viewpoint positions are not overlapped with each other,
assigns the first target viewpoint position group and the second target viewpoint position group to two consecutive frames, and
generates a first target viewpoint image group corresponding to the assigned first target viewpoint position group and a second target viewpoint image group corresponding to the assigned second target viewpoint position group in each of the two frames.

The image generation apparatus according to (5) or (6), in which

the generation control unit is capable of changing the update frame number.

The image generation apparatus according to (5) or (6), in which

the generation control unit changes the update frame number based on a movement of an object to be displayed or a mode set for a multi-viewpoint image display.

The image generation apparatus according to any one of (1) to (8), in which

the generation control unit sets the one or more target viewpoint positions based on an interpupillary distance for each frame and generates the one or more target viewpoint images.

The image generation apparatus according to (5), in which

the generation control unit divides the plurality of viewpoint positions into the plurality of target viewpoint position groups based on the interpupillary distance.

The image generation apparatus according to (1), in which

the second generation unit generates the multi-viewpoint image data of a predetermined frame using the one or more target viewpoint images generated in the predetermined frame and the multi-viewpoint image data generated in a former frame than the predetermined frame.

The image generation apparatus according to any one of (1) to (11), in which

the first generation unit generates a virtual image as the viewpoint image.

The image generation apparatus according to any one of (1) to (11), in which
the first generation unit acquires a plurality of captured images from a plurality of imaging devices arranged in the plurality of viewpoint positions as the plurality of viewpoint images, and
the generation control unit causes the first generation unit to output captured images corresponding to the one or more target viewpoint images and to discard other captured images for each frame.

The image generation apparatus according to (1), in which

the generation control unit sets the one or more target viewpoint positions based on position information of a user for each frame and generates the one or more target viewpoint images.

The image generation apparatus according to any one of (1) to (14), in which

the second generation unit generates the multi-viewpoint image data as data for multi-viewpoint display of a multi-viewpoint display apparatus.

The image generation apparatus according to (15), in which
the multi-viewpoint display apparatus includes a plurality of projectors, and
the second generation unit generates a plurality of corresponding multi-viewpoint image data corresponding to each of the plurality of projectors as the multi-viewpoint image data.

The image generation apparatus according to (15), in which
the multi-viewpoint display apparatus includes a multi-viewpoint display, and
the second generation unit generates the multi-viewpoint image data corresponding to the multi-viewpoint display.

An image generation method executed by a computer system for generating multi-viewpoint image data for displaying a multi-viewpoint image at a predetermined frame rate, including:
setting one or more target viewpoint positions that are part of a plurality of viewpoint positions for each frame;
generating one or more target viewpoint images corresponding to the set one or more target viewpoint positions; and
generating the multi-viewpoint image data using the generated one or more target viewpoint images for each frame.

A program that causes a computer system to execute an image generation method for generating multi-viewpoint image data for displaying a multi-viewpoint image at a predetermined frame rate, the image generation method including:
setting one or more target viewpoint positions that are part of a plurality of viewpoint positions for each frame;
generating one or more target viewpoint images corresponding to the set one or more target viewpoint positions; and
generating the multi-viewpoint image data using the one or more target viewpoint images for each frame.

REFERENCE SIGNS LIST

| | |
|---|---|
| 2 | cartoon character |
| 3 | image displayed corresponding to each viewpoint position |
| 5 | multi-viewpoint display apparatus |
| 6, | 206, 306 image generation apparatus |
| 8 | viewpoint position |
| 10 | first generation unit |
| 11 | generation control unit |
| 12 | second generation unit |
| 13 | viewpoint image |
| 14 | virtual camera |
| 16 | projector |
| 17 | ray control element |
| 18 | strip image |
| 19 | projection image |
| 21 | multi-viewpoint display |
| 22 | flat display panel |
| 23 | lenticular lens |
| 100 | image display system |

What is claimed is:

1. An image generation apparatus that generates multi-viewpoint image data for displaying a multi-viewpoint image at a predetermined frame rate, comprising:
a first generation unit capable of generating a plurality of viewpoint images corresponding to a plurality of viewpoint positions;
a generation control unit that sets one or more target viewpoint positions, which are a part of the plurality of viewpoint positions, for each frame, and causes the first generation unit to generate one or more target viewpoint images corresponding to the set one or more target viewpoint positions; and
a second generation unit that generates the multi-viewpoint image data using the one or more target viewpoint images generated for each frame.

2. The image generation apparatus according to claim 1, wherein
the second generation unit generates the multi-viewpoint image data of a predetermined frame using the one or more target viewpoint images generated in the predetermined frame and the one or more target viewpoint images generated in frames former than the predetermined frame.

3. The image generation apparatus according to claim 1, wherein
the generation control unit generates one or more first target viewpoint images corresponding to one or more first target viewpoint positions in a first frame, and generates one or more second target viewpoint images corresponding to one or more second target viewpoint positions different from any of the one or more first target viewpoint positions in a second frame consecutive to the first frame.

4. The image generation apparatus according to claim 3, wherein
the second generation unit generates the multi-viewpoint image data of the second frame using the one or more first target viewpoint images and the one or more second target viewpoint images.

5. The image generation apparatus according to claim 1, wherein
the generation control unit
sets an update frame number,
divides the plurality of viewpoint positions into a plurality of target viewpoint position groups having the same number as the update frame number and in which the target viewpoint positions are not overlapped with each other,
assigns each of the plurality of target viewpoint position groups to each of consecutive frames of the update frame number, and
generates a target viewpoint image group corresponding to the assigned target viewpoint position group in each of the plurality of frames.

6. The image generation apparatus according to claim 5, wherein
the generation control unit
sets the update frame number to 2,
divides the plurality of viewpoint positions into a first target viewpoint position group and a second target viewpoint position group in which the target viewpoint positions are not overlapped with each other,
assigns the first target viewpoint position group and the second target viewpoint position group to two consecutive frames, and
generates a first target viewpoint image group corresponding to the assigned first target viewpoint position group and a second target viewpoint image group corresponding to the assigned second target viewpoint position group in each of the two frames.

7. The image generation apparatus according to claim 5, wherein
the generation control unit is capable of changing the update frame number.

8. The image generation apparatus according to claim 5, wherein
the generation control unit changes the update frame number based on a movement of an object to be displayed or a mode set for a multi-viewpoint image display.

9. The image generation apparatus according to claim 1, wherein
the generation control unit sets the one or more target viewpoint positions based on an interpupillary distance for each frame and generates the one or more target viewpoint images.

10. The image generation apparatus according to claim 5, wherein
the generation control unit divides the plurality of viewpoint positions into the plurality of target viewpoint position groups based on the interpupillary distance.

11. The image generation apparatus according to claim 1, wherein
the second generation unit generates the multi-viewpoint image data of a predetermined frame using the one or more target viewpoint images generated in the predetermined frame and the multi-viewpoint image data generated in a former frame than the predetermined frame.

12. The image generation apparatus according to claim 1, wherein
the first generation unit generates a virtual image as the viewpoint image.

13. The image generation apparatus according to claim 1, wherein
the first generation unit acquires a plurality of captured images from a plurality of imaging devices arranged in the plurality of viewpoint positions as the plurality of viewpoint images, and
the generation control unit causes the first generation unit to output captured images corresponding to the one or more target viewpoint images and to discard other captured images for each frame.

14. The image generation apparatus according to claim 1, wherein
the generation control unit sets the one or more target viewpoint positions based on position information of a user for each frame and generates the one or more target viewpoint images.

15. The image generation apparatus according to claim 1, wherein
the second generation unit generates the multi-viewpoint image data as data for multi-viewpoint display of a multi-viewpoint display apparatus.

16. The image generation apparatus according to claim 15, wherein
the multi-viewpoint display apparatus includes a plurality of projectors, and
the second generation unit generates a plurality of corresponding multi-viewpoint image data corresponding to each of the plurality of projectors as the multi-viewpoint image data.

17. The image generation apparatus according to claim 15, wherein
the multi-viewpoint display apparatus includes a multi-viewpoint display, and
the second generation unit generates the multi-viewpoint image data corresponding to the multi-viewpoint display.

18. An image generation method executed by a computer system for generating multi-viewpoint image data for displaying a multi-viewpoint image at a predetermined frame rate, comprising:
setting one or more target viewpoint positions that are part of a plurality of viewpoint positions for each frame;
generating one or more target viewpoint images corresponding to the set one or more target viewpoint positions; and
generating the multi-viewpoint image data using the generated one or more target viewpoint images for each frame.

19. A program that causes a computer system to execute an image generation method for generating multi-viewpoint image data for displaying a multi-viewpoint image at a predetermined frame rate, the image generation method comprising:
setting one or more target viewpoint positions that are part of a plurality of viewpoint positions for each frame;
generating one or more target viewpoint images corresponding to the set one or more target viewpoint positions; and
generating the multi-viewpoint image data using the one or more target viewpoint images for each frame.
